(19) United States
(12) Patent Application Publication
(10) Pub. No.: US 2006/0088715 A1
(43) Pub. Date: Apr. 27, 2006

(54) Method for gluing fpcb's

(75) Inventors: Marc Husemann, Hamburg (DE); Kari Hans Engeldinger, Quickborn (DE)

Correspondence Address: NORRIS, MCLAUGHLIN & MARCUS, P.A., 875 THIRD AVE, 18TH FLOOR, NEW YORK, NY, 10022, US

(73) Assignee: Tesa AG, Hamburg (DE)

(21) Appl. No.: 10/543,753

(22) PCT Filed: Dec. 19, 2003
(86) PCT No.: PCT/EP03/14622

§ 371 Date: Jan. 10, 2006

(30) Foreign Application Priority Data
Jan. 29, 2003 (DE) 103 03 518.4
May 30, 2003 (DE) 103 17 403.6

(51) Int. Cl. C08F 8/00; B32B 27/38; B32B 27/00; B32B 27/36

(52) U.S. Cl. 428/413; 428/473.5; 428/480; 525/107; 525/132

(57) ABSTRACT

A method for gluing plastic parts, especially Flexible Printed Circuit Boards (FPCB's), with a thermally-activated adhesive comprising at least one thermoplastic polymer or a modified rubber and at least one resin.

The invention relates to the gluing, i.e., adhesive bonding, of plastics parts, and particularly of flexible printed circuit boards (FPCB's).

Adhesive tapes within the age of industrialization are widespread processing aids. Particularly for use in the electronics industry the requirements imposed on adhesive tapes are very exacting. At the present time there is a trend within the electronics industry toward ever narrower, lighter, and faster components. In order to achieve this, the requirements imposed on the manufacturing operation are becoming ever greater. This also pertains to the flexible printed circuit boards which are used very frequently for the electrical contacting of IC chips or conventional printed circuit boards.

Flexible printed circuit boards (FPCB's) are represented in a multiplicity of electronic devices, such as cellphones, auto radios, and computers, for example. FPCB's are normally composed of layers of copper and polyimide, with the polyimide layer being bonded where appropriate to the copper foil. For the use of the FPCB's they are bonded to other components but also to one another. In the latter case, polyimide film is bonded to polyimide film.

For the bonding of FPCB's it is usual to use heat-activable adhesive tapes which release no volatile constituents and can be used even in a high temperature range. Furthermore, following temperature activation, the heat-activable system ought to be self-crosslinking, in order to withstand a solder bath treatment which usually follows.

Since pure thermoplastics become soft again at high temperatures and so lose their solder bath resistance, their use is generally ruled out. Thermoplastics per se would be preferable, since they can be activated within a few seconds and the bond could be established with corresponding rapidity.

Further heat-activable adhesive tapes, such as the block copolymers described in U.S. Pat. No. 5,478,885 and based on epoxidized styrene-butadiene or styrene-isoprene, possess the disadvantage that they require very long cure times for complete curing and hence significantly slow the processing operation. The same applies to other epoxy-based systems, as are described, for example, in WO 96/33248.

Phenolic resin-based heat-activable adhesive tapes are generally likewise excluded, since they release volatile constituents in the course of curing, and so lead to blistering.

An object of the present invention is therefore to provide a method of adhesively bonding plastics parts, especially FPCB's, that overcomes the disadvantages described above. A particular aim is to find for this utility a heat-activable adhesive system which cures rapidly, is self-crosslinking and solder bath resistant, and adheres well to polyimide.

This object is achieved, surprisingly, through use of an adhesive sheet as characterized in more detail in the main claim. The subclaims provide advantageous developments of the subject matter of the invention.

The adhesive sheet of the invention that is used is thermally activable and particularly suitable for the bonding of FPCB's, and comprises
(i) at least one thermoplastic polymer or one modified rubber and
(ii) at least one resin.

The reactive sheet which becomes tacky on exposure to heat is, accordingly, a mixture of at least one reactive resin which crosslinks at room temperature and forms a three-dimensional polymer network of high strength and of at least one permanently elastic thermoplastic (elastomer) which acts to counter embrittlement of the product.

According to one particularly advantageous embodiment of the invention an adhesive sheet is used which comprises
(i) at least one thermoplastic polymer or one modified rubber and
(ii) at least one tackifying phenolic resin and/or
(iii) at least one epoxy resin.

The adhesive sheet is advantageously composed of the at least one thermoplastic polymer, with a mass fraction in the sheet of 20% to 95% by weight, preferably of 30% to 90% by weight, of the at least one tackifying phenolic resin, with a mass fraction of 5% to 50% by weight, and of the at least one epoxy resin, which where appropriate may also have been admixed with hardeners, and possibly accelerators too, with a mass fraction of 0 to 40% by weight, preferably of 5% to 30% by weight.

The thermoplastic polymer (elastomer) may come preferably from the group of the polyolefins, polyesters, polyurethanes or polyamides or may be a modified rubber, nitrile rubber for example. The particularly preferred thermoplastic polyurethanes (TPUs) are known reaction products of polyester polyols or polyether polyols and organic diisocyanates, such as diphenylmethane diisocyanate. They are composed of predominantly linear macromolecules. Products of this kind are available commercially, mostly in the form of elastic pellets, for example, from Bayer AG under the trade name “Desmocoll”.

By combination of the thermoplastic polymer, especially TPU, with selective compatible resins it is possible to lower the softening temperature of the adhesive sheet sufficiently. In parallel with this there is an increase in the adhesion. Resins which have proven suitable include, for example, certain rosins, hydrocarbon resins or coumarone resins (also called coumarone-indene resins).

Alternatively or additionally to this it is possible to achieve the reduction in the softening temperature of the adhesive sheet by means of the combination of the thermoplastic, in particular TPU, with selected epoxy resins based on bisphenol A and/or bisphenol B, to which a latent hardener may have been added. An adhesive sheet comprising a system of this kind allows a thermal aftercure of the bond, if, for example, an FPCB bonded with the adhesive sheet of the invention is passed through a solder bath.

By means of the chemical crosslinking reaction of the resins, high strengths are achieved between the adhesive film and the substrate that is to be bonded, such as the polyimide film of the FPCB, for example, and a high internal strength is obtained in the product.

The addition of these reactive resin/hardener systems also leads to a reduction in the softening temperature of the aforementioned polymers, which advantageously lowers their processing temperature and processing speed.

In another embodiment of the invention it is possible for hardener systems as well to have been added to the adhesive sheet. Here it is possible to use all of the hardeners known to the skilled worker that lead to a reaction with the phenolic resins and/or with the epoxy resins. All formaldehyde donors come into this category, an example being hexamethylenetetraamine.

When the product is heated there is a short-term reduction in the viscosity, as a result of which the product is able to wet the surface of the substrate that is to be bonded, particularly the polyimide, very well.

The composition of the adhesive sheet can be varied within a wide framework by altering the type of raw material and proportions of raw material. It is also possible to obtain further product properties such as, for example, color, thermal or electrical conductivity by means of targeted additions of colorants, mineral or organic fillers and/or carbon powders and/or metal powders. Preferably the adhesive sheet has a thickness of 5 to 100 μm, more preferably between 10 and 50 μm.

In one particularly preferred embodiment the thermally activable sheet comprises
(i) an elastic modified rubber, especially nitrile rubber, with a mass fraction of 20% to 95% by weight,
(ii) at least one tackifying phenolic resin with a mass fraction of 5% to 50% by weight, and
(iii) at least one epoxy resin, to which hardeners, and possibly also accelerators, may have been added, with a mass fraction of 0 to 30% by weight.

The adhesive sheet is produced by preparing a solution or a melt of the constituents, comprising at least one thermoplastic polymer and at least one resin, pouring or coating out the solution or melt into a thin layer, and subsequently drying the layer if desired. Preferably the composition that forms the sheet is coated as a solution or as a melt onto a flexible carrier substrate (release film, release paper) and is dried if desired, so that the composition can easily be removed again from the substrate. After appropriate converting, diecuts or rolls of this adhesive sheet can be adhered at room temperature or at slightly elevated temperature to the substrate that is to be bonded (e.g., polyimide). The admixed reactive resins ought not to enter into any chemical reaction at the slightly elevated temperature. In this way, bonding need not take place as a one-stage process; instead, for the sake of simplicity, as in the case of a pressure-sensitive adhesive tape, the adhesive sheet can be attached first to one of the two substrates by carrying out thermal lamination. In the actual hot bonding operation to the second substrate (second polyimide film of the second FPCB), the resin then undergoes full or partial curing and the adhesive joint attains the high bond strength, far above those of pressure-sensitive adhesive systems.

The adhesive sheet is particularly suitable, accordingly, for a hotpress process at temperatures above 80° C., preferably above 100° C., more preferably above 120° C.

Unlike other adhesive sheets consisting mostly of pure epoxy resins, the adhesive sheet of this invention has a high elastic component as a result of the high thermoplastic fraction, particularly the rubber fraction. By virtue of the viscoelastic behavior which this brings about, the flexible movements of the FPCB's can be compensated particularly well, so that even high stresses and peeling movements are well withstood.

A further advantage of the adhesive sheet over competitor systems lies in the rapid curing brought about by the phenolic resins. Optimum curing can be achieved under pressure in less than 30 minutes. Competitor systems need significantly more than 60 minutes in order to achieve optimum curing. As a result, the bonds can be produced at a significantly faster rate in an industrial processing operation.

By applying pressure during the bonding of the FPCB's it is also possible to obtain a high solder bath resistance. As a result of the pressure, volatile constituents, which can arise in the course of curing, are forced out of the bonded joint as gaseous constituents. Following complete curing, even with a downstream solder bath, it is no longer possible for any volatile constituents to arise. Consequently, for the inventively preferred use of the adhesive sheet, the bonded joint between the FPCB's is fully cured.

Furthermore, as a result of the high viscoelastic component, the adhesive sheet possesses an advantage over other heat-activable systems. For the purpose of contacting, holes are frequently drilled through the adhesive sheet. A problem here is that existing heat-activable adhesives flow into the holes and so disrupt the contacting. With the inventive use of the above-described adhesive sheets, this problem occurs only to a greatly limited degree, if at all.

Besides the bonding of polyimide-based FPCB's, bonding may also take place to FPCB's based on polyethylene naphthylate (PEN) and polyethylene terephthalate (PET). In these cases as well a high bond strength is achieved with the adhesive sheet.

The invention is elucidated in more detail below in working examples, with reference to the single attached drawing, which depicts the construction of two bonded FPCB's, without any intention that the choice of the examples should restrict the scope of the invention.

Production of the Thermally Activable Adhesive Sheet

### EXAMPLE 1

A mixture of 50% by weight nitrile rubber (Breon®, Zeon), 40% phenolic resin (from Oxychem), 10% phenolic resole resin (Ionomer®, Dyneac Erkner) was coated from methyl ethyl ketone from solution onto a release paper, which was siliconized at 1.5 g/m², and at 90° C. the coated paper was dried at this temperature for 10 minutes. The thickness of the adhesive layer was 25 μm.

### EXAMPLE 2

A mixture of 55% by weight nitrile rubber (Breon®, Zeon), 35% phenolic resin (from Oxychem), 10% phenolic resole resin (Ionomer®, Dyneac Erkner) was coated from methyl ethyl ketone from solution onto a release paper, which was siliconized at 1.5 g/m², and at 90° C. the coated paper was dried at this temperature for 10 minutes. The thickness of the adhesive layer was 25 μm.

### EXAMPLE 3

A mixture of 50% by weight thermoplastic PU (Desmocoll 400®, Bayer AG), 30% phenolic resin (from Oxychem), 10% epoxy resin (Bisphenol A, Rütapox 0164®, Bakelite AG), and 5% by weight dicyanamide (Dyhard 100 S®, Degussa) was coated from methyl ethyl ketone from solution onto a release paper, which was siliconized at 1.5 g/m², and at 90° C. the coated paper was dried at this temperature for 10 minutes. The thickness of the adhesive layer was 25 μm.

The reference example used in the comparative investigations was a commercially available adhesive sheet, namely Pyralux® LF001 from DuPont, with a sheet thickness of 25 μm.

Bonding of FPCB's with the Adhesive Sheet

Two FPCB's were bonded in each case with the adhesive sheets produced according to Examples 1 to 3 and also with the reference sheet (Pyralux® LF001, DuPont). For this purpose the adhesive sheet was laminated onto the polyimide film of the polyimide/copper foil/polyimide FPCB laminate at 100° C. Subsequently this operation was repeated with a second polyimide film of a further FPCB, to produce a bonded joint between two polyimide/copper foil/polyimide laminates, the polyimide films being bonded to one another in each case. The assembly was cured by pressing in a heatable press from Bürkle at 170° C. for 30 minutes under a pressure of 50 N/cm².

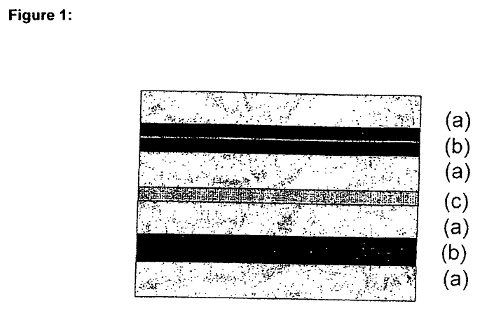

The bonds thus produced had the construction depicted in FIG. 1, where (a) denotes in each case a polyimide layer, (b) denotes in each case a copper layer, and (c) denotes the adhesive sheets. One assembly (a-b-a) of one copper layer (b) with a polyimide layer (a) on either side constitutes one FPCB unit.

Test Methods

The properties of the adhesive sheets produced in accordance with the examples specified above were investigated by the following test methods.

A. T-Peel Test with FPCB

A tensile testing machine from Zwick was used to peel apart the FPCB/adhesive sheet/FPCB assemblies (figure) produced in accordance with the process described above, peeling taking place at an angle of 180° and at a speed of 50 mm/min, and a measurement was made of the force, in N/cm. The measurements were carried out at 20° C. under 50% humidity. Each measured value was determined three times and averaged.

B. Solder Bath Resistance

The FPCB assemblies (figure) bonded in accordance with the process described above were immersed fully for 10 seconds into a hot solder bath at 288° C. The bond was evaluated as being solder bath resistant if no air bubbles were formed which caused the polyimide film of the FPCB to inflate. The test was evaluated as failed if even slight blistering occurred.

C. Bond Strength

The bond strength was measured in analogy to DIN EN 1465. The measured values were reported in N/mm².

Results

For the adhesive assessment of the abovementioned examples the T-peel test with FPCB material was carried out first of all. The corresponding measured values are listed in Table 1.

TABLE 1
Bond strength by the T-peel test

| | Test A/T-peel test |
|---|---|
| | [N/cm] |
| Example 1 | 6.8 |
| Example 2 | 7.0 |
| Example 3 | 7.6 |
| Reference example 1 | 6.5 |

Table 1 reveals that the adhesive sheets produced according to Examples 1 to 3 achieved very high bond strengths after just 30 minutes' curing. The reference example 1 shows somewhat lower bond strengths here.

A further criterion for the application of adhesive sheets to the bonding of FPCB's is the solder bath resistance, which was investigated by test method B. The results are summarized in Table 2.

In Table 2: Solder bath resistance by test method B

| | Test B/solder bath resistance |
|---|---|
| Example 1 | pass |
| Example 2 | pass |
| Example 3 | pass |
| Reference example 1 | pass |

From the results it is apparent that all examples are solder bath resistant and hence meet the requirements of the FPCB industry.

To investigate the capacity of the adhesive sheets to withstand a shearing load, measurement was likewise made of the bond strengths, by test method C. Table 3 lists the corresponding values.

TABLE 3
Bond strength by test method C

| | Bond strength |
|---|---|
| | [N/mm²] |
| Example 1 | 12.0 |
| Example 2 | 16.5 |
| Example 3 | 18.0 |
| Reference example 1 | 6.0 |

Table 3 reveals that the adhesive sheets described in this invention possess a significantly higher bond strength than the reference example.

### REFERENCE SYMBOLS

a Polyimide layer
b Copper layer
c Adhesive sheet

1. A method of adhesively bonding plastics parts, which comprises bonding said plastic parts with a thermally activable adhesive sheet comprising
(i) at least one thermoplastic polymer or one modified rubber and
(ii) at least one resin.

2. The method of claim 1, wherein the plastic to be bonded is selected from the group consisting of polyimides, polyethylene naphthylates, and polyethylene terephthalate.

3. The method of claim 1, wherein said plastic parts are in the form of flexible printed circuit boards.

4. The method of claim 1, wherein the at least one resin of the adhesive sheet comprises
(ii) at least one tackifying phenolic resin and/or
(iii) at least one epoxy resin.

5. The method of claim 1, wherein the at least one thermoplastic polymer has a mass fraction in the adhesive sheet of 20% to 95% by weight.

6. The method of claim 4, wherein the at least one resin comprises at least one phenolic resin and the at least one phenolic resin has a mass fraction in the adhesive sheet of 5% to 50% by weight.

7. The method of claim 4, wherein the at least one resin comprises at least one epoxy resin and the at least one epoxy resin has a mass fraction in the adhesive sheet of between 0% and 40% by weight.

8. The method of claim 1, wherein the at least one resin comprises at least one hardener.

9. The method of claim 1, wherein the at least one resin comprises at least one accelerator.

10. The method of claim 1, wherein the at least one thermoplastic polymer of the adhesive sheet is selected from the group consisting of polyolefins, polyesters, polyurethanes, polyamides, and modified rubber.

11. The method of claim 1, wherein the at least one resin of the adhesive sheet is selected from the group consisting of rosins, hydrocarbon resins, and coumarone resins.

12. The method of claim 1, wherein the adhesive sheet has a thickness of 5 to 100 μm.

13. The method of claim 6, wherein the at least one thermoplastic polymer and the at least one phenolic resin and, where present, the at least one epoxy resin are present in a substantially homogeneous mixture in the adhesive sheet.

14. The method of claim 1, wherein the adhesive sheet comprises
(i) nitrile rubber, with a mass fraction of 20% to 95% by weight,
(ii) at least one tackifying phenolic resin with a mass fraction of 5% to 50% by weight, and
(iii) at least one epoxy resin with a mass fraction of 0 to 30% by weight.

15. A product comprising a plurality of plastic parts bonded together by the method of claim 1.

16. The method of claim 5, wherein said mass fraction is 30-90% by weight.

17. The method of claim 7, wherein said mass fraction is 5% to 30% by weight.

18. The method of claim 12, wherein said thickness is 10 to 50 μm.
